(19) United States
(12) Patent Application Publication
(10) Pub. No.: US 2019/0311509 A1
(43) Pub. Date: Oct. 10, 2019

(54) GENERATION AND PRESENTATION OF DISTANCE CARTOGRAMS

(71) Applicants: University of Washington, Seattle, WA (US); New York University, New York, NY (US)

(72) Inventors: Sungsoo Hong, Seattle, WA (US); Min-Joon Yoo, Seattle, WA (US); Rafal Kocielnik, Seattle, WA (US); Cecilia Aragon, Seattle, WA (US)

(21) Appl. No.: 16/380,677

(22) Filed: Apr. 10, 2019

Related U.S. Application Data
(60) Provisional application No. 62/655,661, filed on Apr. 10, 2018.

(51) Int. Cl. G06T 11/20; G01C 21/26; G06F 16/29

(52) U.S. Cl. CPC G06T 11/206; G06T 2200/24; G06F 16/29; G01C 21/26

(57) ABSTRACT

Technology for generating and presenting distance cartograms, which use region partitioning for scalable construction of time space, is disclosed. A representative method includes obtaining a geospatial graph, receiving a selection of an origin location within the graph, and dividing the first graph into a plurality of regions based on a granularity level. Recursively for each region, the representative method includes determining a travel time variance within the region. If the variance exceeds a threshold, the region is further partitioned into new regions based on a new granularity level. The representative method further includes generating a distance cartogram with respect to the origin location based on a final composition of partitioned regions that may have resulted from different levels of partitioning.

### CROSS-REFERENCE TO RELATED APPLICATION(S)

This application claims the benefit of pending U.S. Provisional Application No. 62/655,661 entitled “Interaction Design for Map Layout Switching,” filed Apr. 10, 2018, and which is incorporated herein by reference in its entirety.

### BACKGROUND

Maps provide an accessible and efficient visualization method for representing geospatial reality. Since maps are configured to reflect real-world geography, individuals can visually determine the Euclidean distance between points on a map. For example, an individual viewing a map representing an urban area, with points of interest connected by available transportation infrastructure (such as walkways, roadways, bus and subway routes, etc.), can visually determine the travel distance between two points based on the total length of a route along the connections multiplied by a scale factor. However, due to various factors such as traffic along the transportation infrastructure, differences in speed limits, road distribution and structure, weather conditions, and mass-transit schedules, the travel time between different points may vary significantly even when the travel distances are substantially the same. As a result, it can be challenging for individuals to predict travel time based on conventional maps.

Various techniques for representing travel times on maps have been used to overcome these shortcomings. For example, some real-time mapping systems have shown roadways with various colors to highlight different levels of traffic congestion in an attempt to enhance geospatial information with geotemporal information. However, colors corresponding to traffic congestion are limited in the precision of information that may be conveyed and require an individual to mentally combine roadways of different colors and different lengths to determine travel time. Alternatively, some systems have generated geographically warped maps in which points on the map are located according to their travel time from other points.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the presently disclosed technology.

FIGS. 4A and 4B illustrate a geospatial map and a distance cartogram representation, respectively, of a region.

FIG. 5 is a flow diagram illustrating a process for generating and presenting a distance cartogram in accordance with some embodiments of the presently disclosed technology.

FIG. 6 illustrates an example process for region partitioning in accordance with a quadtree grid.

FIG. 7 illustrates examples of a user interaction of highlighting with distance cartograms, in accordance with some embodiments of the presently disclosed technology.

FIG. 8 illustrates examples of user interface for presenting distance cartograms, in accordance with some embodiments of the presently disclosed technology.

The techniques introduced herein may be better understood by referring to the following Detailed Description in conjunction with the accompanying drawings, in which like reference numerals indicate identical or functionally similar elements.

### DETAILED DESCRIPTION

The present technology is generally directed to methods and systems for generating, presenting, and interacting with perceptually-intuitive distance cartograms. A distance cartogram is a specialized map projection that visually conveys a mapping variable, such as travel cost, as a substitute for distance. Specifically, a distance cartogram of travel times (hereinafter, a “distance cartogram”) can alter displayed distances between a user-specified origin and other locations on a map, with respect to the travel time between them, to allow users to visually decode the travel time between locations on the map. A distance cartogram can exemplify a type of map that presents geotemporal information instead of or in addition to geospatial information—the latter typically presented on a standard geographic map.

However, creating a distance cartogram can be challenging, since unevenly distributed road infrastructure and unpredictable traffic conditions can introduce discrepancies between the travel time and the travel distance between locations. Additionally, implementation of distance cartogram typically requires construction of a time space (i.e., the space that specifies the shortest travel time from an origin to the rest of locations) per each user interaction (e.g., map panning or zooming) in real time. Accordingly, the computational costs required for constructing interactive distance cartogram can be very high, which presents challenges to the enablement of a variety of map interaction types, such as panning or zooming, in distance cartograms. As will be described in detail below, embodiments of the presently disclosed technology are expected to improve scalability and presentation of distance cartograms. Illustratively, some implementations of the presently disclosed technology can instantiate an interactive system that enables real world users to explore locations with distance cartograms.

In one example, a system configured in accordance with some embodiments of the presently disclosed technology can generate a distance cartogram with respect to an origin location based, at least in part, on region partitioning at varied and controlled granularity. Illustratively, the region partitioning-based method can construct a time space within a few rounds of travel time computations (e.g., via API calls), which enable on-the-fly time space construction. The region partitioning can apply different partitioning granularities based on the degree of traffic congestion of areas shown on a map. For example, some areas (e.g., city centers or downtown areas) with traffic congestion can be subdivided into regions of increasingly smaller sizes, which enables capturing of travel time in a fine-grained manner; whereas areas with less traffic can be subdivided into larger regions. Varied and controlled partitioning (e.g., via recursive subdivision) does not rely on a pre-defined road network structure as typically used in time space construction, and therefore improves computational scalability so that live traffic can be reflected in an accurate manner. The system can control or adjust the accuracy of a constructed time space and/or the amount of time it takes to yield the time space by changing threshold criteria (e.g., measures of travel time variance within a region) for region subdivisions.

The system can enable various types of map interaction designed to improve perceived quality of spatial exploration in real settings. Presenting useful map interactions is expected to lower the barrier of unfamiliarity with distance cartograms and increase the chance of user adoption. For example, a user interface of the system enables “switching,” which smoothly animates the map layout between a “standard” map (e.g., Web Mercator map) and a distance cartogram. Switching allows users to choose a map layout based on their search context and helps gain familiarity with distance cartograms. As another example, a user interface of the system can enable “zooming and panning,” which allows for spatial exploration of distance cartograms by users. As a further example, a user interface of the system enables “highlighting” applicable to isochrones (e.g., circular visual indicators that present a set travel time from the origin). Highlighting allows users to easily compare any location on a map by creating one's own isochrones and resizing (e.g., by dragging).

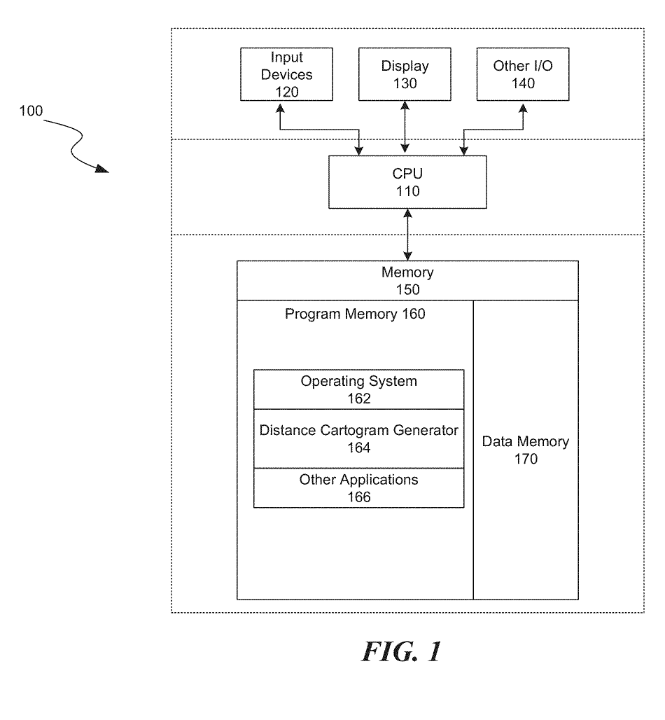

Several implementations are discussed below in more detail with reference to the figures. FIG. 1, for example, is a block diagram illustrating an overview of devices on which some implementations of the presently disclosed technology can operate. The devices can comprise hardware components of a device 100 that generates distance cartograms in accordance with some embodiments of the technology. Device 100 can include one or more input devices 120 that provide input to the CPU (processor) 110, notifying it of actions. The actions can be mediated by a hardware controller that interprets the signals received from the input device and communicates the information to the CPU 110 using a communication protocol. Input devices 120 include, for example, a mouse, a keyboard, a touchscreen, an infrared sensor, a touchpad, a wearable input device, a camera- or image-based input device, a microphone, or other user input devices.

CPU 110 can be a single processing unit or multiple processing units in a device or distributed across multiple devices. CPU 110 can be coupled to other hardware devices, for example, with the use of a bus, such as a PCI bus or SCSI bus, The CPU 110 can communicate with a hardware controller for devices, such as for a display 130. Display 130 can be used to display text and graphics. In some examples, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, FireWire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The CPU 110 can have access to a memory 150. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 150 can include program memory 160 that stores programs and software, such as an operating system 162, distance cartogram generator 164, and other application programs 166. Memory 150 can also include data memory 170 that can include GIS data describing transportation infrastructure for geographical regions, geospatial graphs, travel conditions, configuration data, settings, user options or preferences, etc., which can be provided to the program memory 160 or any element of the device 100 as bases for distance cartogram generation and/or presentation.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

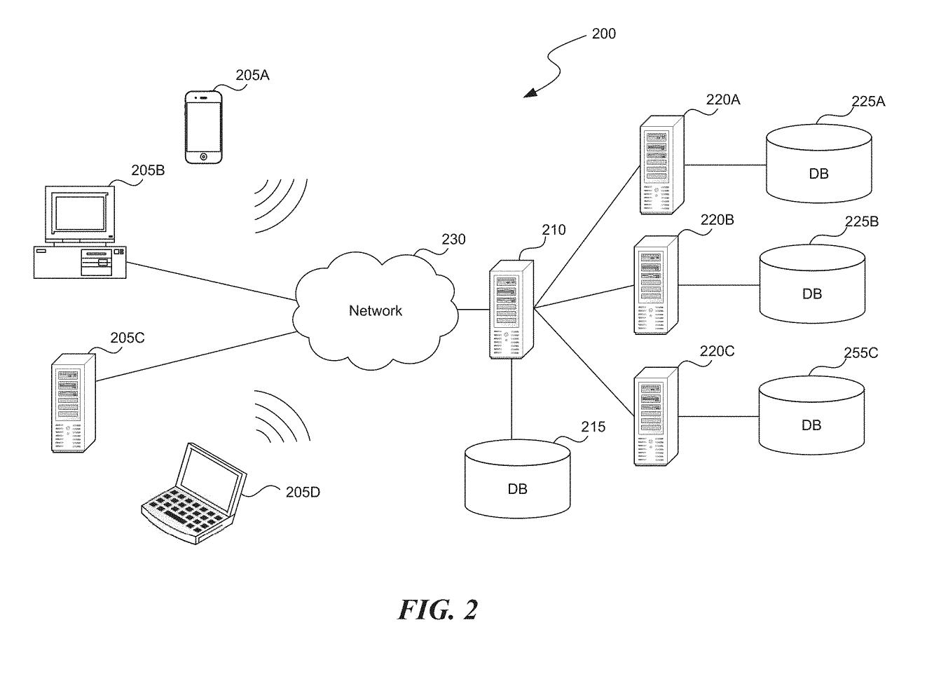

FIG. 2 is a block diagram illustrating an overview of an environment 200 in which some implementations of the presently disclosed technology can operate. Environment 200 can include one or more client computing devices 205A-D, examples of which can include device 100. Client computing devices 205 can operate in a networked environment using logical connections through network 230 to one or more remote computers, such as a server computing device 210.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information such as GIS data, geospatial graphs, and thematic data characterizing travel conditions. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

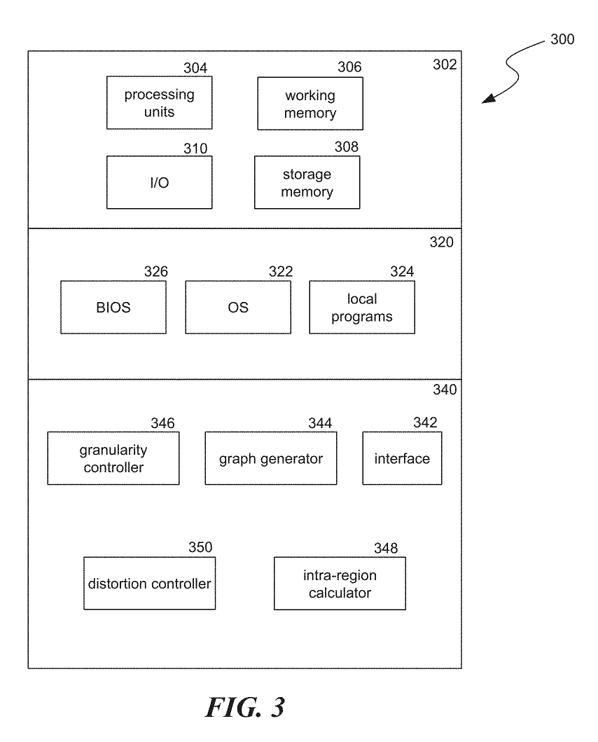

FIG. 3 is a block diagram illustrating components 300 which, in some implementations, can be used in a system employing the presently disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308, and input and output devices 310. Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include graph generator 344, granularity controller 346, intra-region calculator 348, distortion controller 350, and components which can be used for transferring data and controlling the specialized components, such as interface 342. In some implementations, components 300 can be in a computing system that is distributed across multiple computing devices or can be an interface to a server-based application executing one or more of specialized components 340.

User input and data can be received by the interface 342. For example, data from external systems such as current or past travel conditions, data for various graphs such as of road or other transportation infrastructure (e.g., GIS data), and indications of user input indicating interactions with a user interface (UI) such as graph point indications, zoom levels, focus areas, search terms, or time selections can be received by the interface 342.

Graph generator 344 can access, such as through interface 342, transportation infrastructure data, including GIS data and other data describing transportation infrastructures of a region, and generate geospatial graphs for the region. In various implementations, the data describing transportation infrastructures can include roadways, walkways, railways, and public transportation routes. In some implementations, the graph generator 344 can generate a graph by creating control nodes representing intersections or interchanges corresponding to the geographic locations at which infrastructure elements overlap. The geospatial graphs generated by the graph generator 344 or by third party service(s) can correspond to different zoom levels that include different elements of the transportation infrastructure. The system can maintain, such as in a memory or database, the geospatial graphs for use by the system in generating distance cartograms for display to a user.

The granularity controller 346 can determine and set granularity levels for region partitioning. Illustratively, a region of a geospatial graph can be divided into multiple smaller regions for further processing. The granularity controller 346 can set the granularity level for partitioning by indicating a size, shape, orientation, location, and/or other conditions or constraints applicable to individual regions that can result from the partitioning.

The intra-region calculator 348 can compute or otherwise determine intra-region variance of travel time within each region. The intra-region variance can be one or more statistics that describe the distribution of estimated travel times within a region. The variance value can be used to determine whether the region is to be partitioned further at a changed granularity level.

The distortion controller 350 can control the distortion between a standard map (e.g., representing travel distance) and a corresponding distance cartogram. The distortion controller can control the distortion based on the shape and/or topology of a transportation infrastructure (e.g., a road network). When control points from a standard map are gradually shifted to their target locations on a distance cartogram, the distortion controller 350 can measure a shape-preservation metric (e.g., differences of edge length ratios and angles between the two shapes) and/or evaluate topology violations. The shift can be stopped if the shape-preservation metric deviates from certain range or value and/or if topology violation is detected.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

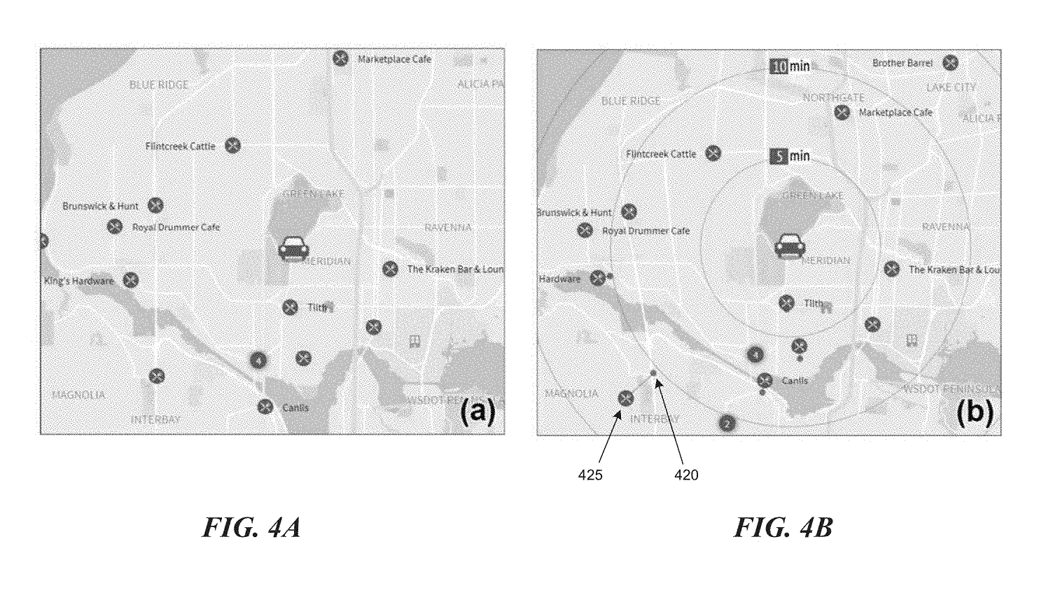

FIG. 4A is an example geographic map of a region. Illustratively, FIG. 4A shows a region of Seattle, Wash., centered at a location near Green Lake, using standard cartography. FIG. 4A can be based, for example, on geospatial data in which the distances between points on the graph are determined by the distances between geographic locations corresponding to those points.

FIG. 4B is an example of a distance cartogram, representing the same region, generated and presented in accordance with some embodiments of the presently disclosed technology. In comparison with FIG. 4A, FIG. 4B is warped according to travel time to or from the centered location (e.g., the origin). In some cases, FIG. 4B can include geo-contextual anchor(s) 425, associated with location(s) of interest 420, to indicate travel time to the location of interest. Though the anchor 425 represents the travel time to the location of interest 420, the distance cartogram of FIG. 4B itself does not warp according to the placement of anchor 425, so that certain topology violations of geography and/or road network (e.g., overlapping landmasses or roads) can be avoided. Information about generating and presenting distance cartograms without creating topological violations and other applicable aspects of the described technology, may be found in U.S. Pat. No. 9,773,321 entitled “Visual Representations of Distance Cartograms,” which is herein incorporated by reference in its entirety.

Typically, three primary steps are involved in a distance cartogram construction process:
Step 1. A network of a target area is built, which is typically a simplified road network including nodes that present geographical locations of an area, and edges that indicate connections between nodes.
Step 2. A time space, which presents the shortest travel times from an origin to the rest of the nodes, is constructed based on a shortest path algorithm.
Step 3. Every node on a network is shifted based on the time space so that the distances between an origin and locations on a map indicate travel time between them.

Presenting accurate live travel time using the typical distance cartogram generation techniques can be difficult. In part, this is due to the high computational costs for constructing a time space (Step 2) per each map interaction query by the user (e.g., zooming or a panning). In most cases, constructing a time space requires execution of a shortest path algorithm from an origin. Illustratively, to ensure constructing a time space within a targeted response time, it is necessary to maintain the number of nodes and edges to a certain degree so that the system can finish execution of the shortest path algorithm within the time. However, the size of a network can quickly grow larger than a system can handle within the given time, especially when considering a complex road network of urban areas.

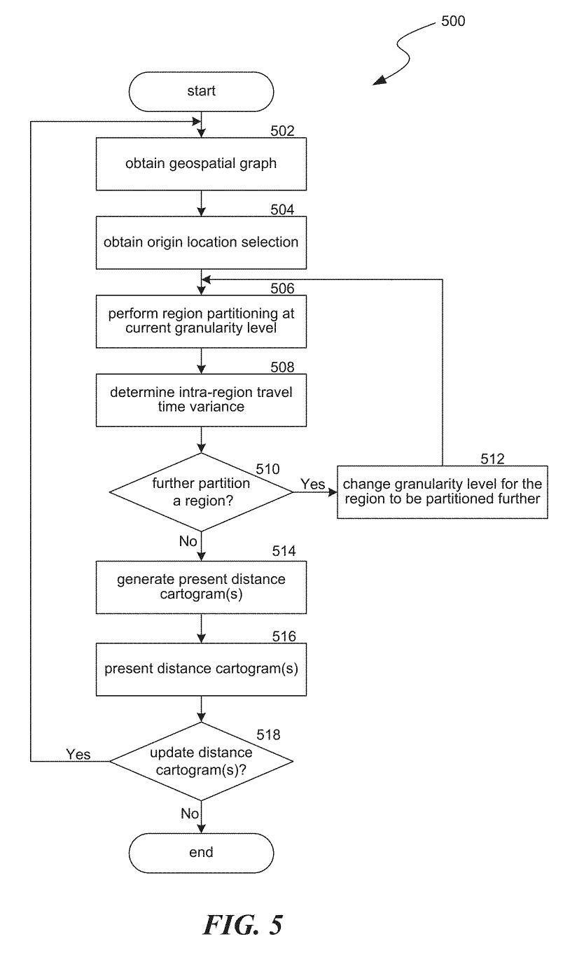

FIG. 5 is a flow diagram illustrating a process 500 for generating and presenting a distance cartogram in accordance with some embodiments of the presently disclosed technology. Portions of process 500 can be implemented to construct a time space without relying on a road network and/or shortest path algorithms.

At block 502, process 500 can include obtaining a geospatial graph. The geospatial graph can describe the transportation infrastructure of a region, in which points, lines, and/or other geographic indicators are placed according to their geospatial relationships (e.g., representing travel distance). The obtained geospatial graph can be for a particular geographic region, and at a particular level of zoom, according to the instruction of, for example, a user. Process 500 can retrieve the geospatial graph from a database or other data store where geospatial graphs for the region and other regions, at various levels of zoom, can be maintained. In various embodiments, the geospatial graph can represent a chip design layout, tourist sites topology, airline travel routes, city layout, or other physical space.

At block 504, process 500 can include obtaining the selection of an origin or starting location within the geospatial graph. The selected origin location can be a user identified point on the graph, the result from a search, a default point such as the center of a current view area, a system selected point (such as an identified accident site), or another point selected by a system or system user.

At block 506, process 500 can include performing region partitioning at a current granularity level. Illustratively, the geospatial graph can be divided into multiple smaller regions for further processing. A current granularity level can be a basis for the partitioning. The current granularity level can indicate, for example, a size, shape, orientation, location, and/or other conditions or constraints applicable to individual regions that can result from the partitioning. In some embodiments, the region partitioning can be based on the selected origin location, such as dividing at least a portion of the geospatial graph into multiple smaller regions (e.g., in triangle, rectangle, and/or other polygon shapes) that have the origin as a common vertex (or corner). The regions resulted from the partitioning can be added to a working data set for further processing.

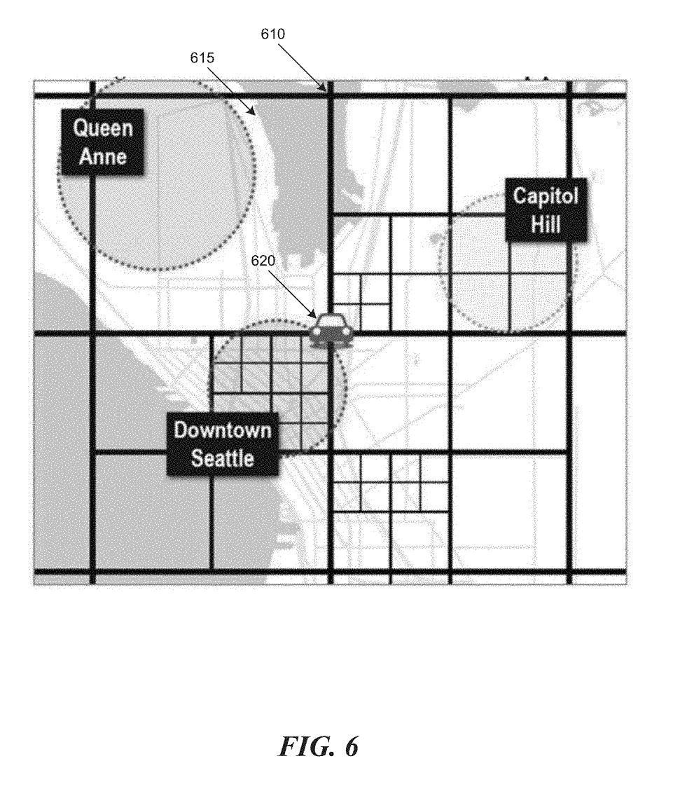

As an example, FIG. 6 illustrates the region partitioning in accordance with a quadtree grid. To construct a quadtree grid, process 500 can include constructing a Cartesian grid that spans the area presented on a screen (which may represent the entire geospatial graph or a portion thereof). As shown in FIG. 6, the grid 610 made with the thickest strokes is an example of the Cartesian grid. The Cartesian grid defines the current granularity level and the geospatial graph is divided into multiple smaller regions (in equal-sized square shape), which are added to a working data set for further processing.

At block 508, process 500 can include determining intra-region travel time variance. Illustratively, for each region included in the working data set, process 500 can determine travel times between multiple locations within the region and the origin location. The travel time determining can be based on live travel conditions, for example, based on data indicating current travel throughput through the transportation infrastructure (i.e., traffic conditions) as well as other concurrent factors that can influence travel time. In some embodiments, the travel time determining can be achieved via one or more third party services. For example, with reference to the quadtree based partitioning as shown in FIG. 6, for each region in the working data set, process 500 can call travel time API (e.g., Google Distance Matrix API) four times to obtain travel time from the origin location 620 to the four corners of the region.

Process 500 can then determine intra-region variance of travel time for each region. Illustratively, the intra-region variance can be one or more statistics (e.g., maximal differential, minimal differential, standard deviation, or the like) calculated based on the travel times determined for a corresponding region. For example, with reference to the quadtree based partitioning as shown in FIG. 6, for each region in the working data set, process 500 can calculate six travel time differentials between every pair of the four travel times and use the largest differential as the intra-region variance for the region. In some embodiments, the process can determine whether the four corners all represent locations above the land. Points) representing location over the water or is otherwise inaccessible can be excluded from the travel time determination.

At decision block 510, process 500 can include determining whether there exists a region in the working data set to partition further, based on the intra-region travel time variance of the region. If so, process 500 proceeds to block 512; otherwise process 500 proceeds to block 514. For a region that is currently being processed, process 500 can evaluate its intra-region travel time variance using one or more criteria (e.g., thresholds or conditions). Illustratively, if the intra-region variance of a region satisfies the one or more criteria by exceeding a threshold value, process 500 can determine that the region needs to be partitioned into smaller regions (e.g., based on changed granularity level) in order to properly serve as a basis for time space construction. For example, with reference to the quadtree based partitioning as shown in FIG. 6, for a currently processed region, if its intra-region variance exceeds a threshold θₜᵢₘₑ (e.g. 4 minutes), this means the traffic condition in the region is uneven enough to justify further partition based on finer granularity.

At block 512, process 500 includes changing the granularity level for a region to be partitioned further. The changed granularity level can indicate a smaller size, different shape, different orientation, different location, and/or other changed conditions or constraints applicable to individual regions that can result from the further partitioning of the region. For example, with reference to the quadtree based partitioning as shown in FIG. 6, the changed granularity level can indicate that the region is to be partitioned into four equal-sized smaller square regions. Process 500 can then proceed back to block 506 where the particular region is partitioned further based on the changed granularity level. The smaller regions resulted from the further partitioning can be added to the working data set to replace the particular region. As those skilled in the art would understand, in some embodiments, the further partitioning can be implemented as a depth-first recursive process applied to the working data set; and in some embodiments, the further partitioning process can be implemented as a width-first traversal process applied to the working data set.

In some embodiments, the changed granularity level can be based on the geographic attributes, road network and/or distribution, traffic conditions, or other factors of the particular region that is to be further partitioned. For example, the changed granularity level can require the region orientation and/or shape to align with the road orientations within the region. As another example, the changed granularity level can include the size and/or number of subdivided regions as determined based on the value of the intra-region variance (e.g., a larger intra-region variance can lead to smaller subdivided regions).

At block 514, process 500 can include generating one or more distance cartogram(s) that reflect present traffic conditions. In this regard, the regions (e.g., resulting from partitions and further partitions based on different granularity levels) included in the working data set can be used to construct a time space. Illustratively, the travel times associated with each region can serve as base points for constructing a travel time “field” that cover the entire geospatial graph. As those skilled in the art would understand, various linear or non-linear fitting methods can be used to construct this “field” which, as a form of time space, allows for estimating of travel time from the origin to any location on the geospatial graph.

For example, a quadtree based partitioning can result in a working data set reflected in the final regions layout as defined by the final quadtree grid (in black) shown in FIG. 6. To estimate a travel time from the origin location to any point within a particular region, the process 500 can use the point's relative position within the region to calculate a linearly interpolated value based on the travel times between the origin and the four corners of the region. In some embodiments, the travel time estimation can additionally take into account base points (e.g., one or more corners) of other region(s) (e.g., those bordering the region where the point resides) to achieve better estimation accuracy or smoother transitions between regions.

Referring back to FIG. 5, process 500 can generate the distance cartograms based on the constructed time space by distorting (e.g., “warping”) each region of the working data set and/or control points therein, and thereby generating a second graph reflecting “travel time” distance of different locations relative to the origin. As described above, FIG. 4A is an example of the geospatial graph obtained and FIG. 4B is an example of the generated distance cartogram corresponding to the geospatial graph.

In some embodiments, the distorting can be constrained by the shape and/or topology of a road network. For example, process 500 can use every intersection and corner point in the road network as control points for applying the distortion. Process 500 can calculate target coordinates for each control point based on an estimated travel time to reach the control point and gradually shift the control points toward their target coordinates. Upon each shift, process 500 can measure a shape-preservation metric (e.g., differences of edge length ratios and angles between the two shapes) and/or evaluate topology violations. The shift stops if the shape-preservation metric deviates from certain range or value and/or if topology violation is detected.

At block 516, process 500 includes presenting the generated distance cartogram(s). User interface for presenting the generated distance cartogram(s) can effectively support users' location searching, among other functionalities. For example, major location types (e.g., Restaurant, Cafe, Travel attractions, Shopping, Nightlife, or the like) can be included in the interface for user selection. Each type can have its sub-category (e.g., travel attractions include landmarks, museums, parks, beaches, etc.). For each selected location, the user interface can present: the place name, average user ratings, price range ($˜$$$$), the number of user reviews (as a proxy of popularity), place categories, address, phone number, geolocation, images, highlights, review, or the like. The information can be collected from third party databases or services. A set of filters can also be included in the interface to allow users to iteratively refine locations.

The distance cartogram presentation in accordance with some embodiments of the presently disclosed technology can further improve perceived quality of spatial exploration in real settings. Presenting useful map interactions can lower the barrier of unfamiliarity with distance cartograms and increase the chance of adoption. Illustratively, presenting of distance cartogram can include “switching,” where the user interface smoothly animates the map layout between a “standard” map of the obtained geospatial graph and the generated distance cartogram. In some embodiments, the animation is computed and presented after the distance cartogram is generated. In some embodiments, the animation is computed and presented while the region partitioning process is ongoing, based on applicable intermediate data values obtained therefrom. The user interface presenting the distance cartogram can also enable user interactions such as (a) zooming and panning, (b) setting the origin by touching, button tapping, and/or address typing, and/or (c) selecting different modes of transportation for travel time estimation.

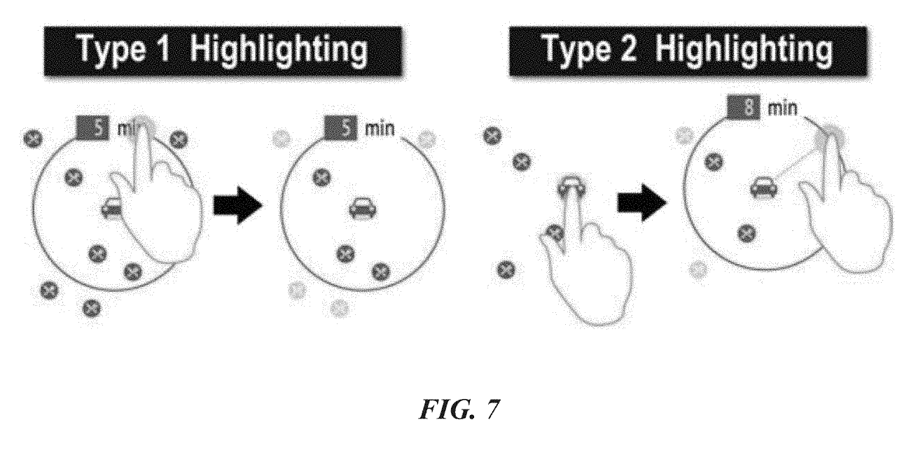

In some embodiments, the user interface for presenting distance cartograms enables a user interaction type called “highlighting.” As distance cartogram can position locations based on a radial layout, users may face difficulty in comparing travel times from the origin to two locations as the angle formed by the two locations and the origin gets wider. To overcome this limitation, among other benefits, the interface can enable highlighting with the use isochrones (e.g., circular visual indicators that present a set travel times from the origin). Highlighting can allow users to easily compare any location on a map by creating one's own isochrones and resizing by dragging. Highlighting can visually emphasize locations within a circle by making locations outside the isochrones semi-transparent. As shown in FIG. 7, highlighting can be triggered by the user in two ways. Type 1: tap on an existing isochrone (see FIG. 7, left), or Type 2: tap on the origin or existing isochrones and drag inwards or outwards (see FIG. 7, right).

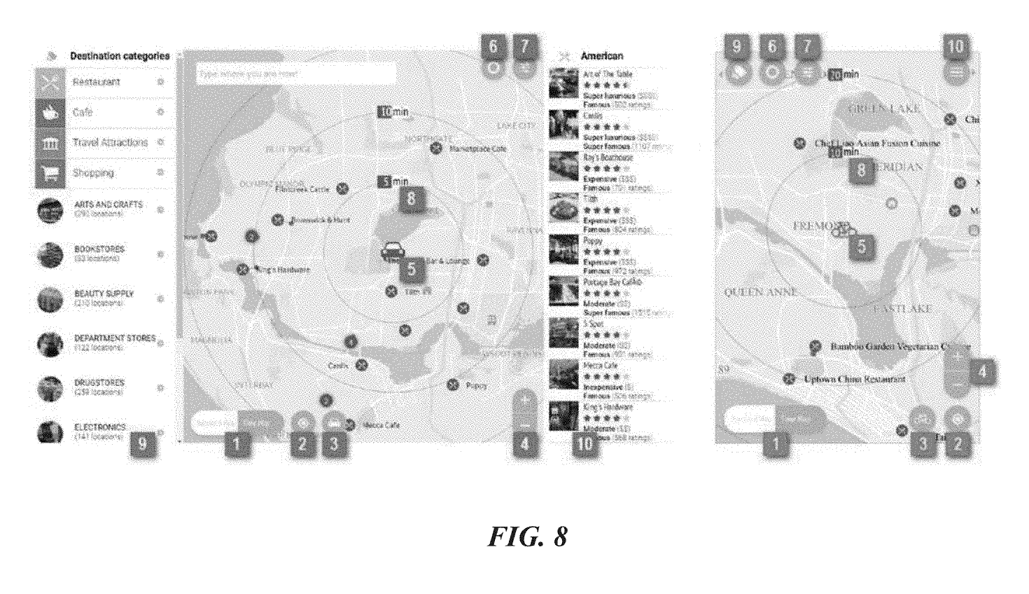

As an example of the user interface for presenting the generated distance cartogram(s). FIG. 8 shows an interface designed for desktop display (see FIG. 8, left) and another interface designed for mobile display (see FIG. 8, right). The user interfaces can include:
Switching toggle (Box 1): triggers switching between “Standard Map” and “Time Map.”
Resetting origin button (Box 2): resets the origin to the current GPS information.
Mode of transportation button (Box 3): presents a pop up that help users to select one of the mode of transportation among vehicle, bicycle, or on foot.
Zoom buttons (Box 4): trigger map zoom interaction.
Modification of the origin (Box 5) is designed in two different ways. In the desktop UI, a user can type an address. In the mobile a user can long-press the origin and drag it in the WM mode. Changing an origin can be disabled in the “Time Map” mode for both desktop and mobile.
Setting button (Box : opens a popup where a user can set the addresses of their home and office.
Filter button (Box 7): opens a screen that presents filters.
Highlighting (Box 8): can be triggered in the “Time Map” mode when tapping an existing isochrone (Type 1) or when tapping an origin or an existing isochrone and dragging inward or outward (Type 2).
List of location types (Box 9): presents available types of locations within a screen.
List of locations nearby (Box 10): presents locations of interest within a screen.

Referring back to FIG. 5, at decision block 518, process 500 includes determining whether to update the generated distance cartogram(s). If so, process 500 proceeds back to block 502; otherwise process 500 ends. In some embodiments, one or more user interactions with the presented distance cartogram can trigger updating of the distance cartogram(s). Illustratively, a geospatial graph of a different geographic region and/or at a different zoom level needs to be obtained, a different origin location needs to be obtained, and/or the most up-to-date travel conditions needs to be obtained for generating the updated distance cartogram(s).

As discussed above, a distance cartogram is a specialized map projection that visually conveys a mapping variable as a substitute for distance. While the above description of process 500 primarily uses “travel time” as an example of the mapping variable, other mapping variable(s) can be used to generate corresponding distance cartograms. Illustratively, any time a measure of value is applied to a representation in physical space, that measure of value can constitute a mapping variable. This include, for example, chip design layout where connections are evaluated based on time and/or power consumption, maps of tourist sites where paths between major points of interest are evaluated based on time traveled and/or interest level of areas along the path, airline travel between cities evaluated based on airfare, smart city planning mapped based on aesthetics, views, and/or availability of consumer goods. As those skilled in the art would understand, the technology disclosed herein can be applied to many other situations where an objective function is applied to a representation in physical space.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiples of any item such as A and A; B, B, and C; A, A, B, C, and C; etc. As used herein, the phrase “and/or” as in “A and/or B” refer to A alone, B alone, and both A and B.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A computer-implemented method for generating a distance cartogram, the method comprising:
obtaining a first graph including a geospatial representation of an area;
receiving a selection of an origin location within the first graph;
dividing the first graph into a plurality of regions based, at least in part, on the origin location;
for each region of the plurality of regions:
determining travel times between a plurality of locations of the region and the origin location;
determining whether a subset of the travel times exceeds a differential threshold; and
in response to determining that the subset of the travel times exceeds the differential threshold, dividing the region into further regions to add to the plurality of regions; and
generating a distance cartogram with respect to the origin location based, at least in part, on the plurality of regions and the travel times determined for each region.

2. The method of claim 1, further comprising displaying the distance cartogram via a second graph.

3. The method of claim 2, wherein displaying the distance cartogram is performed in response to a user interaction with the first graph.

4. The method of claim 3, wherein the user interaction the first graph includes a selection of a switching toggle displayed on the first graph.

5. The method of claim 2, wherein displaying the distance cartogram includes presenting an animation between the first graph and the second graph.

6. The method of claim 1, wherein dividing the first graph into a plurality of regions is based, at least in part, on a first granularity level.

7. The method of claim 6, wherein dividing the region into further regions is based, at least in part, on a second granularity level.

8. The method of claim 6, wherein the first granularity level indicates at least one of a size, shape, orientation, or location applicable to individual regions that can result from the dividing of the first graph.

9. The method of claim 1, wherein determining travel times between a plurality of locations of the region and the origin location comprises determining travel times between corners of the region and the origin location.

10. A computer-readable storage medium storing instructions that, when executed by a computing system, cause the computing system to perform actions comprising:
partitioning a region of a geospatial map in accordance with a current granularity level;
determining an intra-region variance of travel time between the region and an origin location;
in response to determining that the intra-region variance satisfy at least one partitioning criterion:
determining a new granularity level for further partitioning the region; and
partitioning the region into a plurality of new regions in accordance with the new granularity level; and
generating a distance cartogram based, at least in part, on the plurality of new regions.

11. The computer-readable storage medium of claim 10, wherein the region results from a prior partitioning of a prior region in accordance with a prior granularity level.

12. The computer-readable storage medium of claim 10, wherein the new granularity level indicates at least one of a size, shape, orientation, or location applicable to individual regions that can result from the partitioning of the region.

13. The computer-readable storage medium of claim 10, wherein determining the new granularity level is based, at least in part, on at least one of geographic attributes, road distribution, traffic conditions, or the intra-region variance.

14. The computer-readable storage medium of claim 10, wherein determining the intra-region variance of travel time comprises determining travel times from the origin location to a plurality of locations within the region.

15. The computer-readable storage medium of claim 14, wherein the intra-region variance includes at least one statistics based, at least in part, on the determined travel times.

16. A system comprising:
at least one processor; and
memory storing contents that, when executed by the at least one processor, cause the system to:
partition a region of a geospatial map in accordance with a current granularity level;
determine an intra-region variance of travel time between the region and an origin location;
in response to determining that the intra-region variance satisfy at least one partitioning criterion:
determine a new granularity level for further partitioning the region; and
partition the region into a plurality of new regions in accordance with the new granularity level; and
generate a geotemporal map based, at least n part, on the plurality of new regions.

17. The system of claim 16, wherein determining that the intra-region variance satisfy at least one partitioning criterion comprises determining that the intra-region variance exceeds a time difference threshold.

18. The system of claim 16, wherein generating the geotemporal map comprises estimating travel times from the origin location to one or more other locations based, at least in part, on a subset of the plurality of new regions.

19. The system of claim 16, wherein the contents, when executed by the at least one processor, further cause the system to cause presentation of the geotemporal map.

20. The system of claim 19, wherein the contents, when executed by the at least one processor, further cause the system to:
receive one or more user interactions with the presented geotemporal map; and
generate an updated geotemporal map in response to receiving the one or more user interactions.
